(19) United States
(12) Patent Application Publication
(10) Pub. No.: US 2006/0238103 A1
(43) Pub. Date: Oct. 26, 2006

(54) Photo-luminescence liquid crystal display

(75) Inventors: Jae-young Choi, Suwon-si (KR); Byung-ki Kim, Gunpo-si (KR); Seoung-jae Im, Seoul (KR); Eun-sung Lee, Seoul (KR); Kyung-sang Cho, Gwacheon-si (KR); Eun-Joo Jang, Daejeon-si (KR)

Correspondence Address: BUCHANAN, INGERSOLL & ROONEY PC, POST OFFICE BOX 1404, ALEXANDRIA, VA, 22313-1404, US

(73) Assignee: SAMSUNG Electronics Co., Ltd., Suwon-si (KR)

(21) Appl. No.: 11/405,555

(22) Filed: Apr. 18, 2006

(30) Foreign Application Priority Data
Apr. 25, 2005 (KR) 10-2005-0034014

(51) Int. Cl. H01J 1/62

(52) U.S. Cl. 313/486

(57) ABSTRACT

Provided is a photo-luminescence (PL) LCD including: electrodes that are disposed on bottom and top surfaces of front and rear substrate and create an electric field in liquid crystals (LCs); a nano-dot (ND) PL layer that is disposed on the bottom surface of the front substrate and emits light when irradiated with ultraviolet (UV) light, and a UV backlight unit that is located behind the rear substrate and supplying UV light to the ND PL layer. The UV backlight unit is excited by blue UV light having a wavelength range of 360 to 460 nm to emit light. The PD LCD having the above-mentioned structure suppresses absorption of UV light by LC and degradation of the LC while providing high light efficiency.

### CROSS-REFERENCE TO RELATED PATENT APPLICATION

Priority is claimed to Korean Patent Application No. 10-2005-0034014, filed on Apr. 25, 2005, in the Korean Intellectual Property Office, the disclosure of which is incorporated herein in its entirety by reference.

### BACKGROUND OF THE DISCLOSURE

1. Field of the Disclosure

The present disclosure relates to a liquid crystal display (LCD) and a photo-luminescence (PL)-LCD with high light efficiency.

2. Description of the Related Art

LCDs are non-emissive displays and need a separate backlight device to display an image on a screen. LCDs also require Red (R), Green (G), and Blue (B) color filters for their respective pixels to display a color image.

The R, G, and B color filters respectively separate white light emitted by a backlight device into red, green, and blue. The R, G, and B color filters each transmit only light of a specific wavelength that is one third of that of the white light, resulting in significant optical loss. Thus, a high brightness backlight device is needed to produce an image with sufficient brightness.

In U.S. Pat. No. 4,830,469, Breddels et al. propose a PL LCD using phosphors to improve the low light efficiency of an LCD using color filters.

In the proposed LCD, a mercury lamp emitting UV light having a wavelength of about 360 to 370 nm is used as a light source and a front substrate plate contains phosphors. However, because some of the UV light is absorbed by liquid crystals, the amount of UV light used for excitation of phosphors decreases. The absorbed UV light also degrades the liquid crystals, thus reducing their life span. Furthermore, the LCD using some color filters instead of a color filter-free structure still suffers from optical loss.

U.S. Pat. No. 6,844,903 B2 discusses an LCD using a blue light source with a wavelength of 460 nm and red and green phosphors. However, the wavelength of the light source of this LCD is reduced because light emitted from the light source is used for blue pixels with no phosphor being deposited over the blue pixels.

Thus, the most challenging task for a PL LCD is to prevent degradation of liquid crystals due to UV light and obtain maximum light emission efficiency by absorbing a sufficient amount of light.

### SUMMARY OF THE DISCLOSURE

The present disclosure provides a photo-luminescence (PL) LCD with high light efficiency and long life span by preventing degradation of liquid crystals due to excitation of phosphor by ultraviolet (UV) light.

According to an aspect of the present disclosure, there is provided a PL LCD including: an ultraviolet (UV) backlight unit; front and rear substrates; liquid crystals that are sandwiched between the front and rear substrates and optically switch UV light emitted by the UV backlight; an electrode creating an electric field in the liquid crystals and driving the liquid crystals; and a nano-dot (ND) PL layer emitting light when irradiated with the UV light passing through the liquid crystals.

The UV backlight unit may include a blue LED light source. The UV light has a wavelength of 360 to 360 nm.

The ND PL layer contains at least one semiconductor nanoparticle selected from the group consisting of a II-IV compound, a III-IV compound, a IV-VI compound, a Group IV compound, and a mixture of the compounds. Alternatively, the ND PL layer may contain an inorganic phosphor and a semiconductor nanoparticle selected from the group consisting of a II-IV compound, a III-IV compound, a IV-VI compound, a Group IV compound, and a mixture of the compounds.

The II-IV compound is selected from the group consisting of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe. The III-V compound semiconductor is selected from the group consisting of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb. The IV-VI compound is selected from the group consisting of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe. The Group IV compound is selected from the group consisting of Si, Ge, SiC, and SiGe.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a cross-sectional view of an LCD according to an embodiment of the present disclosure;

FIG. 2 shows an example of a backlight of the LCD of FIG. 1;

FIG. 3 shows another example of the backlight of the LCD of FIG. 1;

FIG. 4 is a cross-sectional view showing the structure of a switching element and a pixel electrode in an LCD according to an embodiment of the present disclosure;

FIGS. 5-7 are graphs respectively showing changes in photo-luminescence (PL) intensity for cadmium selenide (CdSe) nano-dot (ND), cadmium sulfide (CdS) ND, and cadmium selenide sulfide (CdSeS) ND; and

FIG. 8 illustrates absorption spectra with respect to composition and size (diameter) of an ND.

### DETAILED DESCRIPTION OF THE DISCLOSURE

The present disclosure will now be described more fully with reference to the accompanying drawings, in which exemplary embodiments of the disclosure are shown.

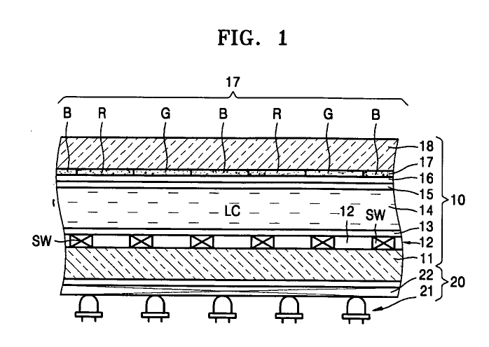

Referring to FIG. 1, an LCD according to an embodiment of the present disclosure includes a display panel 10 and a blue ultraviolet (UV) light source unit 20. The display panel 10 includes a front substrate 18 and a rear substrate 11 spaced from each other by a predetermined distance and a liquid crystal (LC) layer 14 sandwiched between the front and rear substrates 18 and 11.

A photo-luminescence (PL) layer 17 containing red (R), green (G), and blue (B) layers is disposed on an inner surface of the front substrate 18. A common electrode 16 and an upper alignment layer 15 are sequentially formed on the PL layer 17. A plurality of thin-film transistor (TFT) switching elements SW and a plurality of pixel electrodes 12 and a lower alignment layer 13 are sequentially disposed on the rear substrate 11. The PL layer 17 absorbs blue UV light to emit colored light and contains nano-dot (ND) inorganic phosphors that will be described in more detail later.

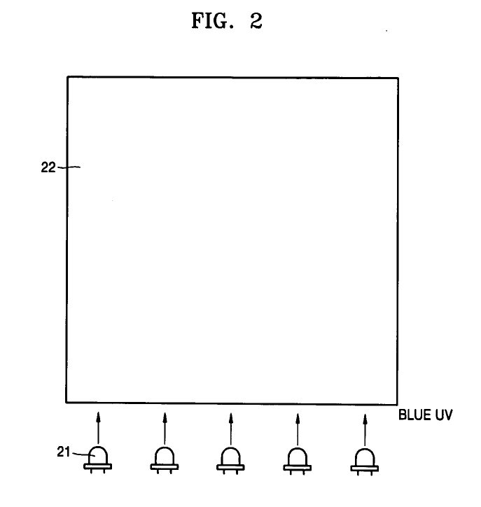

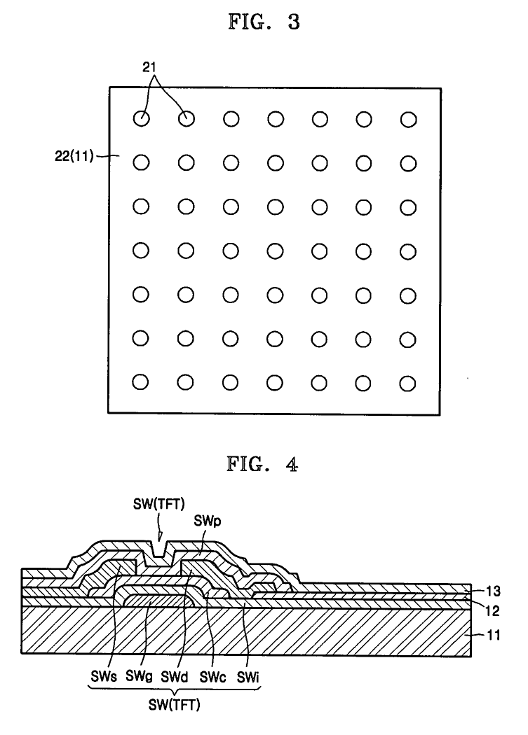

The blue UV light source unit 20 is located behind the rear substrate 11 and includes a blue UV lamp 21 and a light guide/diffusion element 22. The blue UV lamp 21 may be an array of blue light-emitting diodes (LEDs), a blue Cold Cathode Fluorescent Lamp (CCFL), or a plasma lamp. The light guide/diffusion element 22 is disposed between the blue UV lamp 21 and the rear substrate 11 and guides and uniformly diffuses UV light from the blue UV lamp 21 toward the rear substrate 11. The light guide/diffusion element 22 is optional and the blue UV lamp 21 has a size corresponding to the entire surface of the rear substrate 11. For example, when LEDs are used as the blue UV lamp 21, a plurality of LEDs may be densely arranged in a two-dimensional array. When the blue UV lamp 21 is a CCFL or plasma lamp, the blue UV lamp 21 has a size corresponding to the rear substrate 11. Preferably, blue LEDs may be used as a light source. When the blue UV lamp 21 is an array of blue LEDs, the blue LEDs 21 may be arranged along a line parallel to one edge of the light guide/diffusion element 22 as shown in FIG. 2. Alternatively, as shown in FIG. 3, the blue LEDs 21 may be arranged on the entire surface of the light guide/diffusion element 22 corresponding to the entire surface of the rear substrate 11.

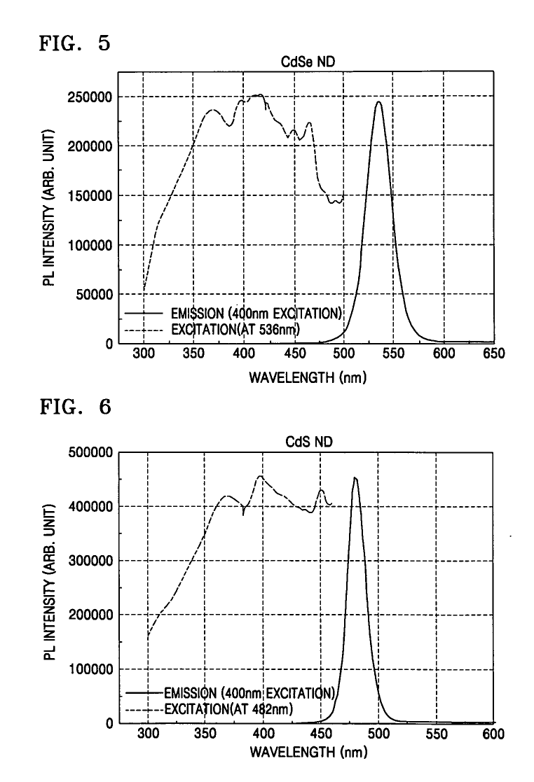

FIG. 4 is a cross-sectional view showing a vertical structure of a switching element SW that is a thin film transistor (TFT) and a pixel electrode 12 connected to the switching element SW in an LCD according to the present disclosure. Referring to FIG. 4, the TFT has a bottom gate structure in which a gate SWg is disposed under a silicon channel SWc. More specifically, the gate SWg is formed on one side of a substrate 11 and a gate insulating layer SWi is formed over the substrate 11 on which the gate SWg has been formed. The silicon channel SWc is formed on the gate insulating layer SWi immediately above the gate SWg and a transparent indium tin oxide (ITO) pixel electrode 12 is located on the gate insulating layer SWi and adjacent to the silicon channel SWc. A source SWs and a drain SWd are formed on either side of the silicon channel SWc and a passivation layer SWp is formed on the source SWs and drain SWd. The drain SWd extends onto and is electrically connected to the pixel electrode 12. A lower alignment layer 13 is formed on the TFT switching element SW and the pixel electrode 12 and is in contact with LC and aligns the LC to a specific orientation.

The feature of the LCD having the above-mentioned construction is that the light source emits blue UV light. Although in the above description the LEDs are used as a light source, a UV-emitting plasma lamp or CCFL may also be employed to produce blue UV light.

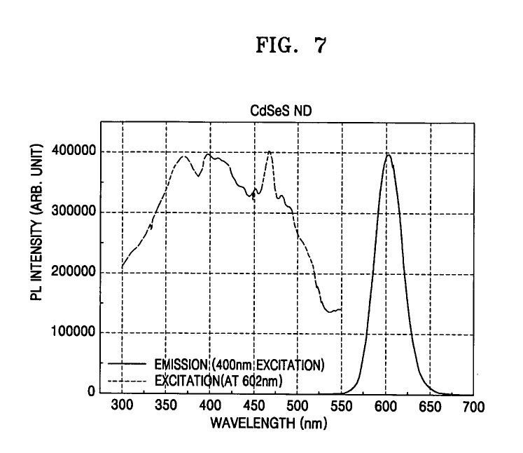

FIGS. 5-7 are graphs respectively showing changes in photo-luminescence (PL) intensity for cadmium selenide (CdSe), cadmium sulfide (CdS), and cadmium selenide sulfide (CdSeS) that are photo-luminescent materials. In FIG. 5, the dotted line denotes a intensity of the green light having a wavelength of 536 nm emitted when the UV light with a wavelength of 300˜500 nm is irradiated, and the solid line denotes a spectrum of the green light having a wavelength of 536 nm emitted when the UV light with a wavelength of 400 nm is irradiated. In FIG. 6, the dotted line denotes a intensity of the blue light having a wavelength of 482 nm emitted when the UV light with a wavelength of 300˜470 nm is irradiated, and the solid line denotes a spectrum of the blue light having a wavelength of 482 nm emitted when the UV light with a wavelength of 400 nm is irradiated. In FIG. 7, the dotted line denotes a intensity of the red light having a wavelength of 602 nm emitted when the UV light with a wavelength of 300˜550 nm is irradiated, and the solid line denotes a spectrum of the red light having a wavelength of 602 nm emitted when the UV light with a wavelength of 400 nm is irradiated.

Referring to FIG. 5, a CdSe ND has a maximum PL intensity at a wavelength near 420 nm and emits green (G) light with a central wavelength of 530 nm when excited by UV light with a wavelength of 400 nm. Referring to FIG. 6, a CdS ND has a maximum PL intensity at a wavelength around 420 nm and emits blue (B) light with a central wavelength of about 480 nm when excited by UV light with a wavelength of 400 nm. Referring to FIG. 7, a CdSeS ND has a maximum PL intensity at a wavelength near 465 nm and emits red (R) light with a central wavelength of about 600 nm when excited by UV light with a wavelength of 400 nm.

As evident from the graphs of FIGS. 5-7, R, G, and B colored light can be emitted upon excitation with UV light with a wavelength of 400 nm. Because only a small amount of the UV light is absorbed by LC, no degradation of LC occurs. In the present disclosure, the UV light has a wavelength range of 360 nm to 460 nm.

An ND (or quantum dot (QD)) refers to a semiconductor particle of a predetermined size showing a quantum confinement effect. The quantum dots have a diameter of 1 to 10 nm and may be synthesized by commonly known techniques such as a wet chemistry method and vapor decomposition. The wet chemistry method allows particles to grow by mixing a precursor material in an organic solvent. The vapor decomposition allows particles to grow in the gas phase using chemical vapor decomposition (CVD), sputtering, laser, or plasma. Basically, the wavelength of light emitted by a semiconductor nanoparticle can be adjusted by changing the size of the nanoparticle.

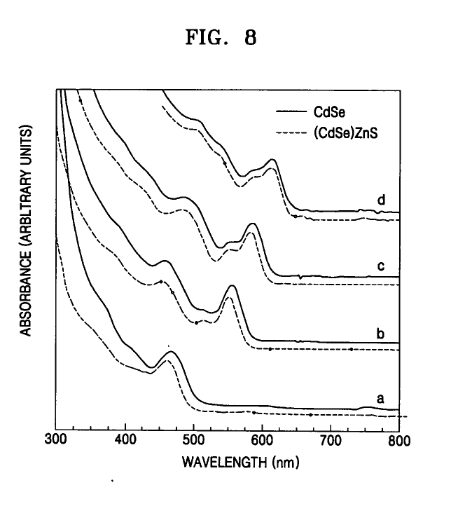

The PL layer is composed of NDs or QDs. It is well known that the wavelength of light emitted by a semiconductor particle can be tuned by a quantum size effect that allows adjustment of a band-gap by changing the size of the particle (See J. Phys. Chem 1996. 100, 13226-132290). For example, as shown in FIG. 8, the wavelength of light emitted by a CdSe particle (II-VI compound) may be changed by controlling the size of the particle. Dotted curves a through d in FIG. 8 respectively show light absorption spectra when the diameter of CdSe particle is 23 Å, 42 Å, 48 Å, and 55 Å while solid lines a through d respectively show light absorption spectra when the diameter of ZnS-overcoated CdSe particle are 23 Å, 42 Å, 48 Å, and 55 Å.

Thus, R, G, and B phosphors can be implemented by changing the size of semiconductor particle. The semiconductor particle is excited to emit light by a band-gap for the particle. Thus, when a desired emission wavelength is 460 nm, any UV light having a wavelength shorter than 460 nm can be used to excite a semiconductor particle. The present disclosure differs from a conventional LCD in which when a desired phosphor emission wavelength is 460 nm, excitation occurs at a specific wavelength shorter than 460 nm. Thus, in the present disclosure, a wavelength shorter than a blue wavelength can be selected as a wavelength of the UV light for exciting the R, G, and B phosphors. The present disclosure can realize an LCD by determining the compositions and sizes of phosphors emitting red, green, and blue and using the UV light having a wavelength range of 360 to 460 nm, not exceeding a blue wavelength of 460 nm.

The available compositions of a semiconductor nanoparticle in the present disclosure include a II-IV compound, a III-IV compound, a IV-VI compound, a Group IV element or compound, a mixture of the compounds, or a core-shell structure consisting of the compounds (e.g., a CdSe core and a CsS shell).

The II-VI compound is selected from the group consisting of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe.

The III-V compound semiconductor is selected from the group consisting of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb.

The IV-VI compound is selected from the group consisting of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe. The Group IV element or compound is Si, Ge, SiC, or SiGe.

Thus, for example, when the R, G, and B layers in the PL layer 17 are formed from RCdSeS, CdS, and CdSe, respectively, there can be obtained an LCD that emits light when excited by UV light having a wavelength range of 360 to 460 nm, preferably, 400 nm that will be only slightly absorbed by LCs. A PL LCD using conventional phosphors not only necessitates the use of UV light having a wavelength shorter than 400 nm, which is however absorbed into LC and degrades the LC, but also has only 70% light efficiency. Conversely, the PL LCD of the present disclosure allows the use of UV light having a wavelength longer than 400 nm along with a ND light-emitting layer, thereby providing an increased life span by preventing degradation of LC and increasing to more than 90% light efficiency.

While the present invention has been described with reference to a TFT active matrix LCD, a simple matrix LCD without any switching element may be used.

The present disclosure uses a ND that can be excited by long-wavelength UV to emit light to prevent degradation of liquid crystal thus reduction in the life span of the display. Furthermore, the present disclosure also provides a display offering high image quality by using a highly efficient ND.

While the present invention has been particularly shown and described with reference to exemplary embodiments thereof, the invention should not be construed as being limited to the embodiments set forth herein; rather, these embodiments are provided so that this disclosure will be thorough and complete, and will fully convey the concept of the invention to those skilled in the art. It will be understood by those of ordinary skill in the art that various changes in structure and arrangement may be made therein without departing from the spirit and scope of the present invention as defined by the following claims.

What is claimed is:

1. A photo-luminescence (PL) liquid crystal display (LCD) comprising:
an ultraviolet (UV) backlight unit;
front and rear substrates;
liquid crystals that are sandwiched between the front and rear substrates and optically switches UV light emitted by the UV backlight;
an electrode creating an electric field in the liquid crystals and driving the liquid crystals; and
a nano-dot (ND) PL layer emitting light when irradiated with the UV light passing through the liquid crystals.

2. The PL LCD of claim 1, wherein the ND PL layer contains at least one semiconductor nanoparticle selected from the group consisting of a II-IV compound, a III-IV compound, a IV-VI compound, a Group IV compound, and a mixture of the compounds.

3. The PL LCD of claim 1, wherein the ND PL layer contains an inorganic phosphor and a semiconductor nanoparticle selected from the group consisting of a II-IV compound, a III-IV compound, a IV-VI compound, a Group IV compound, and a mixture of the compounds.

4. The PL LCD of one of claim 2, wherein the II-IV compound is selected from the group consisting of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe,
wherein the III-V compound semiconductor is selected from the group consisting of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb,
wherein the IV-VI compound is selected from the group consisting of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe, and
wherein the Group IV compound is selected from the group consisting of Si, Ge, SiC, and SiGe.

5. The PL LCD of one of claim 3, wherein the II-IV compound is selected from the group consisting of CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe,
wherein the III-V compound semiconductor is selected from the group consisting of GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb,
wherein the IV-VI compound is selected from the group consisting of SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe, and
wherein the Group IV compound is selected from the group consisting of Si, Ge, SiC, and SiGe.

6. The PL LCD of claim 4, wherein the backlight unit comprises a light-emitting diode (LED) lamp.

7. The PL LCD of claim 5, wherein the backlight unit comprises a light-emitting diode (LED) lamp.

8. The PL LCD of claim 1, wherein the backlight unit comprises a light-emitting diode (LED) lamp.

9. The PL LCD of claim 3, wherein the backlight unit comprises a light-emitting diode(LED) lamp.

10. The PL LCD of claim 6, wherein the backlight unit comprises a light guide/diffusion plate guiding and uniformly diffusing light from the LED lamp toward the entire surface of the rear substrate.

11. The PL LCD of claim 7, wherein the backlight unit comprises a light guide/diffusion plate guiding and uniformly diffusing light from the LED lamp toward the entire surface of the rear substrate.

12. The PL LCD of claim 8, wherein the backlight unit comprises a light guide/diffusion plate guiding and uniformly diffusing light from the LED lamp toward the entire surface of the rear substrate.

13. The PL LCD of claim 9, wherein the backlight unit comprises a light guide/diffusion plate guiding and uniformly diffusing light from the LED lamp toward the entire surface of the rear substrate.

14. The PL LCD of claim 10, wherein a plurality of LED lamps are disposed along one edge of the light guide/diffusion plate.

15. The PL LCD of claim 11, wherein a plurality of LED lamps are disposed along one edge of the light guide/diffusion plate.

16. The PL LCD of claim 12, wherein a plurality of LED lamps are disposed along one edge of the light guide/diffusion plate.

17. The PL LCD of claim 13, wherein a plurality of LED lamps are disposed along one edge of the light guide/diffusion plate.
